(19) United States
(12) Patent Application Publication
(10) Pub. No.: US 2018/0356245 A1
(43) Pub. Date: Dec. 13, 2018

(54) FUELING STATION REROUTING

(71) Applicant: FORD GLOBAL TECHNOLOGIES, LLC, Dearborn, MI (US)

(72) Inventor: Victoria Leigh SCHEIN, Dearborn, MI (US)

(73) Assignee: Ford Global Technologies, LLC, Dearborn, MI (US)

(21) Appl. No.: 15/778,557

(22) PCT Filed: Nov. 24, 2015
(86) PCT No.: PCT/US2015/062392

§ 371 Date: May 23, 2018

(51) Int. Cl. G01C 21/36; G07C 5/04; G01C 21/34; G01C 21/20

(52) U.S. Cl. CPC G01C 21/3617; G07C 5/04; G01C 21/3664; G01C 21/20; G01C 21/3461

(57) ABSTRACT

A computer-implemented method includes detecting, at a navigation system, a button press on a human interface device separate from the navigation system based on a signal received from the human interface device. The method also includes determining one or more fueling preferences for a vehicle and, in response to the button press, rerouting the vehicle to a fueling location that meets the one or more fueling preferences for the vehicle without further input from a user.

### CROSS-REFERENCE TO RELATED APPLICATION

This application is the U.S. national phase of PCT Application No. PCT/US2015/062392 filed on Nov. 24, 2015, the disclosure of which is incorporated in its entirety by reference herein.

### TECHNICAL FIELD

The disclosure relates generally to methods, systems, and apparatuses for selecting a fueling station or selecting a route to a fueling station.

### BACKGROUND

Automobiles provide a significant portion of transportation for commercial, government, and private entities. Frequently, accidents result from driver distraction due to manipulation or use of electronic equipment such as mobile phones, navigation systems, radios, or the like. Due to the high value of automobiles and potential harm to passengers, drivers, and payloads, reductions in driver distraction can be very beneficial.

For example, a driver may be distracted by manual entry of a request in a global positioning system (GPS), such as for a route to a fueling station. Such manual entry of a request into a GPS is distracting and dangerous for a driver because it diverts the driver's attention, including the driver's eyes and/or hands for long enough time periods to enter a request and/or manipulate an electronic device. Limiting distractions for a driver is important because it reduces the chances of an accident occurring.

### SUMMARY

In a first illustrative embodiment, a computer-implemented method includes detecting, at a navigation system, a button press on a human interface device separate from the navigation system based on a signal received from the human interface device. The method also includes determining one or more fueling preferences for a vehicle and, in response to the button press, rerouting the vehicle to a fueling location that meets the one or more fueling preferences for the vehicle without further input from a user.

In a second illustrative embodiment, a system includes a human interface device comprising a button and a transceiver, wherein the transceiver is configured to send a signal responsive to button activation. The system also includes a processor configured to detect the button activation based on receipt of the signal. The processor is further configured to determine a predefined vehicle fueling preference and route the vehicle to a fueling location that meets the fueling preference without further user input following button activation.

In a third illustrative embodiment, a system includes a processor configured to detect a press of a vehicle-mounted, but otherwise unconnected button device, based on a wireless signal received from the button device. The processor is also configured to determine a vehicle fueling preferences, wherein the preference including at least one of a vehicle type, a fuel type, or a fuel brand. The processor is additionally configured to route the vehicle to a fueling location that meets the vehicle fueling preference without further user input.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic block diagram illustrating an illustrative implementation of a vehicle refueling station routing system;

FIG. 2 is a schematic diagram illustrating a view from within a cab of a vehicle, according to one illustrative implementation;

FIG. 3 is a schematic diagram illustrating a road map and routes on the road map, according to one illustrative implementation;

FIG. 4 is a schematic block diagram illustrating components of a fueling station component, according to one illustrative implementation; and

FIG. 5 is a schematic flow chart diagram illustrating a method for routing a vehicle to a fueling station, according to one illustrative implementation.

### DETAILED DESCRIPTION

When a navigation system or global positioning system (GPS) reroutes a user to a nearest fueling station when a vehicle is low on fuel, it can be useful to route the user to a fueling station specific to their vehicle's fuel type and user's fuel preferences. Also, it is useful to reroute the user without the user having to touch their mobile device so the user stays focused on the road and the task of driving. Many users have diesel trucks and need diesel fuel. Thus, it is useful in those circumstances that a user is routed to a fueling location that meets the vehicle's fuel characteristics.

When the user is navigating on a set route and realizes the need to refuel the vehicle, a GPS may show all nearest fueling stations. Currently, however, mobile GPS navigation systems do not take into account the vehicle characteristics or the user's fuel preferences. For example, if a user is driving in a diesel vehicle, simply finding a fueling station close to their location may not work because the close fueling station may not sell diesel fuel. Thus, Applicants have recognized a use for a navigation system or GPS that knows vehicle parameters (e.g., fuel consumption, fuel type, time of last refuel) and user's fuel preferences (e.g., preferred fuel or fueling location brand).

Furthermore, manual entry of a request in a GPS for a new route to a fueling may divert a user's attention, including the user's eyes and/or hands for long enough time periods to enter a request and/or manipulate an electronic device. Applicants have further recognized a use for a vehicle accessory (or another human interface device, such as a push button) that can send a user command via Bluetooth to a phone, in-dash navigation system, or other navigation system to reroute a vehicle to a nearest fueling station based on the vehicle and user preferences.

The vehicle information and user preferences may be inputted previously and/or stored by a mobile device or on a remote server before driving. For example, a mobile computing device may include an application that communicates with a vehicle accessory (human interface device) using Bluetooth or another wireless standard. The application may take into account a vehicle's or user's brand preferences, preferred or required fuel type, and other fueling preferences to successfully provide the user an ideal new route catered to their preferences to efficiently and safely navigate the user to the closest preference-matching station. Applicants have recognized that existing systems do not disclose a human interface device that, when activated by a driver, causes a separate system to automatically reroute the vehicle to a nearest fueling station (that satisfies vehicle fuel requirements and pre-defined driver fuel preferences) without further driver input.

According to one illustrative embodiment, a fueling station rerouting system includes a vehicle accessory (e.g., mechanical push button) and a mobile application executed by a user's mobile computing device or a vehicle's GPS system to provide an easy way for drivers to navigate to the nearest gas station.

In one embodiment, a user may input a vehicle type, fuel type, gas price range, fuel preference, gas station brand(s) of preference, and/or other user fuel based preferences into the mobile application. The vehicle information and user preferences may be stored in memory by the mobile application or GPS system (e.g., a smart phone or in-dash navigation system). The mobile application may send the information to a GPS system or other navigation system (if different than the mobile computing device executing the mobile application) so that GPS or other navigation system will know these user preferences when it reroutes a user to the nearest fueling station.

In one illustrative embodiment, a user will attach a custom fit vehicle accessory in a vehicle. For example, the vehicle accessory may include a Bluetooth wireless human interface device (e.g., a mechanical push button) that is or can be mounted to a steering wheel, dash, or any other location that is easily accessible while driving. The vehicle accessory may include a button, switch, or other interface device that a user can press or select to indicate that the user (or vehicle) needs gas and wants to be relocated or routed to the nearest matching fueling station. The navigation system, or accompanying mobile application, may be in communication (via a wire or wireless communication connection) with the vehicle accessory.

For example, a Bluetooth signal may be provided by the vehicle accessory each time a button is pressed. In response to receiving a Bluetooth signal that indicates the button was pressed, the navigation system may log or determine the GPS location of the vehicle and the corresponding time. Based on the button press, GPS location, and current time, the navigation system or mobile application may use any previously input fuel preferences or vehicle characteristics to route to a closest fueling station that meets the preferences.

For example, rather than providing all possible gas stations within close proximity to the user's location as a result, only a single one, or a small number of gas stations or fueling locations that match the previously input fuel preferences or vehicle characteristics may be provided. In one embodiment, the mobile application or navigation system may automatically reroute the user to the closest fueling location that matches the previously input fuel preferences or vehicle characteristics without further input from the user.

For example, all a user may need to do is press a button and then follow routing instructions from a navigation system to navigate to a fueling station that meets all the needs and preferences of the user and the vehicle. The user may not need to press or select any buttons or options on a mobile device or navigation system to do any of the rerouting. For example, the vehicle accessory with the human interface device (e.g., a mechanical button) may be used to receive all of the user commands and requests for rerouting.

In one embodiment, a fueling station rerouting system includes a human interface device and a computing device or system running a mobile application. The human interface device may include a button or touch sensor that is easily accessible for drivers. The human interface device may receive user input, which may be used to determine that a user is requesting to be routed to a refueling station and to tag a vehicle's current GPS location and time. The mobile application may communicate with a GPS system (e.g., an in-dash navigation system of a vehicle or a navigation application on the same mobile computing device on which the mobile application is executed) to record the location and time data in response to detecting a button press on the human interface device. The mobile application or navigation system may reroute the user to a nearest fueling station based on the user preferences or vehicle characteristics stored in memory or accessible over a wireless connection.

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to utilize such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed in greater detail below. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like.

The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

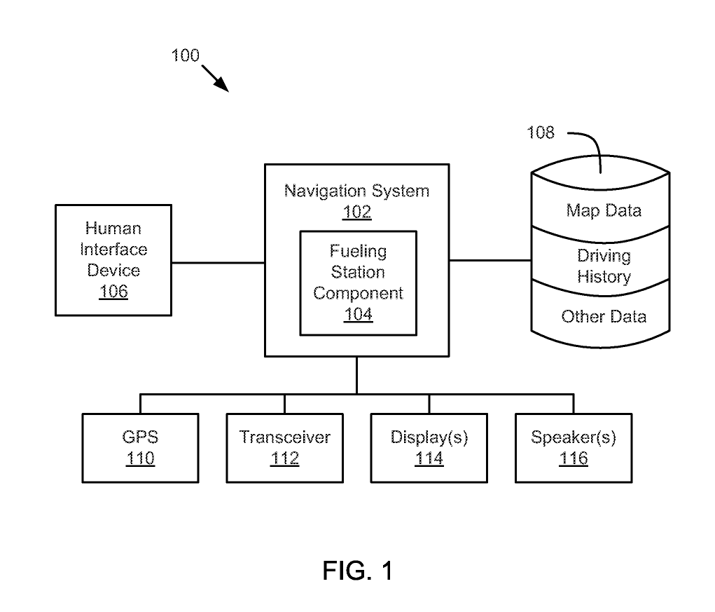

Referring now to the figures, FIG. 1 illustrates a vehicle refueling station routing system 100. The vehicle refueling station routing system 100 may be used to quickly and automatically route a user to a fueling station in response to a user interacting with a push button or other human interface device. The vehicle refueling station routing system 100 includes a navigation system 102, a fueling station component 104, and a human interface device 106. The vehicle refueling station routing system 100 may also include a data store 108, a GPS 110, a transceiver 112, a display 114, and a speaker 116. The components 102-116 of the vehicle refueling station routing system 100 are provided by way of example only and may not all be included in all embodiments. In fact, some embodiments may include only one or only two or more of the components 102-116. Furthermore, the components 102-116 may be combined or separated into different devices or systems without limitation. For example, the fueling station component 104 may be located on a smartphone, while the navigation system 102 may be part of an in-dash navigation system of a vehicle.

The navigation system 102 may include a system that routes a vehicle along a path to a destination. For example, the navigation system 102 may include an in-dash or vehicle mounted mapping and navigation system, such as a vehicle's GPS. As another example, the navigation system 102 may include a mobile computing device such as a smart phone, tablet, or other computer. The navigation system 102 may include a processor, circuitry, and/or software for routing a vehicle to a destination. Example existing navigation systems may include a mapping or routing system or software from Google Garmin®, Apple®, Tom Tom®, Magellan®, or the like. For example, existing navigation systems may be modified to include a fueling station component 104 (discussed below) or may communicate with or receive instructions from a fueling station component 104 to implement at least a portion of the functionality or realize an apparatus or system disclosed herein.

The fueling station component 104 is configured to route a vehicle to a nearest fueling station that meets one or more vehicle and user preferences. For example, the fueling station component 104 may detect input on the human interface device 106 indicating that a user wishes to refuel a vehicle. The fueling station component 104 may reference one or more vehicle characteristics or user preferences to select a fueling station and may route the vehicle to the fueling station. In one embodiment, the fueling station component 104 may receive a signal from the human interface device 106 indicating a request to refuel and may provide one or more preferences, or a specific fueling station, to the navigation system 102 for routing to a fueling station that meets the preferences.

The human interface device 106 may include a human interface to receive input from a user. For example, the human interface device may include a push button, a switch, a capacitive touch sensor, or any other human-machine interface where input by a user may be detected. In one embodiment, the human interface device 106 also includes a signal generator that generates a signal in response to input from a user. For example, the human interface device 106 may provide a wired or wireless signal in response to a button press. In one embodiment, the signal may indicate that the user pressed a button or otherwise provided input into the human interface device. In one embodiment, the navigation system 102 or fueling station component 104 may detect the signal from the human interface device 106 and determine, based on the signal, that a user wishes to be routed to a fueling station.

Data store 108 may store data for operation of the navigation system 102 and/or fueling station component 104. For example, the data store 108 may store map data for roads or locations over which a vehicle may navigate or travel. The data store 108 may include information about a driving history of the vehicle or one or more other vehicles. The data store 108 may also store other data such as user preferences, vehicle characteristics, or information about gas stations or refueling stations. The refueling stations may include any type of station used to replenish fuel or an energy source of a vehicle. For example, refueling stations may provide diesel fuel, gasoline, hydrogen, ethanol, electrical energy, natural gas, or any other type of fuel or energy for replenishing an energy source, gas tank, or battery of a vehicle.

The GPS 110 may include a GPS receiver and may determine a location of the GPS receiver and accompanying vehicle. The GPS location may be useful in locating the vehicle on a map so that a route from a current location to a destination may be computed and instruction for navigation provided to a user or vehicle. The transceiver 112 may include one or more transceivers or radios for receiving wired or wireless signals. In one embodiment, the transceiver 112 may include one or more of a Bluetooth radio, a Wi-Fi radio, a ZigBee radio, or a radio for communication over a wireless communication network, such as a network that implements a 3^{rd} Generation Partnership Project (3GPP) standard. The display(s) 114 may provide visual information to a user to instruct the user to follow a route, such as a route to a fueling station. Similarly, the speaker(s) 116 may provide audio information to a user to instruct the user to follow a route.

According to one example scenario, the vehicle refueling station routing system 100 may reroute a user to the nearest fueling station. The navigation system 102 may determine a vehicle's current location, a current time, user fuel specific fueling station preferences, and vehicle characteristics. For example, the user fuel specific fueling station preferences, and vehicle characteristics may be previously entered and stored in the data store 108 or at a location accessible using the transceiver 112 (e.g., over the Internet). Based on the preferences, the navigation system 102 may route the vehicle to the closest fueling station (or the closest fueling station along a future route of a vehicle) based on the vehicle characteristics and/or user preferences. This may allow a user to be routed to a fueling location that meets a vehicle's needs and/or a user's preferences without requiring a user to stop their drive to pick a gas station and request a new route from the GPS, or attempt to reroute to a gas station while driving.

For example, the human interface device 106 may send a command to the navigation system 102 or fueling station component 104 via Bluetooth. In response to the command, the navigation system 102 or fueling station component 104 may reroute the user to the nearest fueling station based off the vehicle's characteristics and user's preferences without having to interact with the navigation system while driving.

For example, a user will not need to stop to search through a list of fueling stations for the ideal fuel location for the user and the vehicle because the human interface device 106 is interactable while the user stays focused on the road and without the user having to interact with a mobile device or in-dash system. In one embodiment, the fueling station component 104 or navigation system 102 will filter out all of the stations that do not fit the user's needs or preferences or the vehicle's characteristics. In one embodiment, voice recognition may also be used by the navigation system 102 or fueling station component 104 to allow for easier input of parameters rather than having to type-in or manipulate a device to choose from a list of gas stations close to the user's location. In one embodiment, the user's preferences and the vehicle's characteristics can be changed or modified at any time and a mobile application corresponding to the fueling station component 104 or navigation system 102 may be used in any vehicle.

In one embodiment, a vehicle accessory (e.g., the human interface device 106 or mechanical push button device) may be used with a mobile application that communicates with a mobile computing device, such as a phone, or vehicle's GPS system for rerouting a vehicle to the nearest fueling station. The mobile application and/or vehicle's GPS system may provide a mobile fueling station rerouting platform that allows for filtering of fueling stations based on previously entered or provided user preference data such as fuel type, vehicle type, price range, gas station brand, and other fuel specific user based preferences. For example, a user may have a gas card or a rewards card that works at only fueling locations of a specific brand and may wish to only refuel at those locations to save money or obtain rewards.

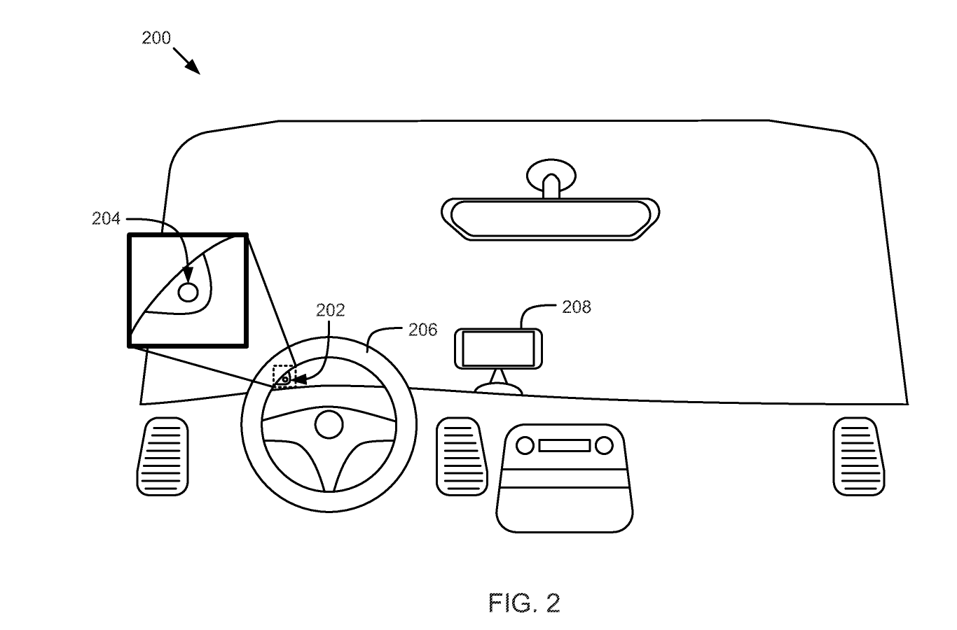

FIG. 2 is a schematic dash view 200 of a vehicle. The dash view 200 illustrates a vehicle accessory 202 that includes a button 204 (shown in an enlarged view), which may be selected by a user. In an embodiment, the vehicle accessory 202 may include an accessory that has been built into the steering wheel, strapped or otherwise attached (e.g., an after-market addition) to the steering wheel. The vehicle accessory 202 may be positioned on a steering wheel 206 of the vehicle to allow a driver to easily locate and press the button 204 without significantly diverting the driver's attention away from driving or the road. In one embodiment, the vehicle accessory 202 may include an accessory that is built-in or otherwise attachable (e.g., an after-market addition) to a portion of the vehicle, such that the accessory is readily available to a driver to allow the driver to easily locate use the accessory 202 without significantly diverting the driver's attention away from driving or the road.

In one embodiment, the vehicle accessory 202 may be a button 204 or other graphic or icon displayed on a graphical user interface of a computing device to allow a driver to easily locate and press the button 204 without significantly diverting the driver's attention away from driving or the road. Such a graphic or icon may be part of a vehicle's infotainment system or may be part of an application running on a mobile computing device or smart phone without departing from the scope of the disclosure.

A smart phone 208 or other mobile computing device is shown mounted on a dash of the vehicle. The smart phone 208 may receive a signal or command from the vehicle accessory 202 that indicates that the vehicle should be routed to a fueling station. The smart phone 208 may perform operations of one or more of the navigation system 102 or fueling station component 104 of FIG. 1 to route the vehicle to the nearest fueling station that meets one or more preferences of a user and/or requirements or characteristics of a vehicle. In one embodiment, an in-dash system may be used as the navigation system and/or the fueling station component 104.

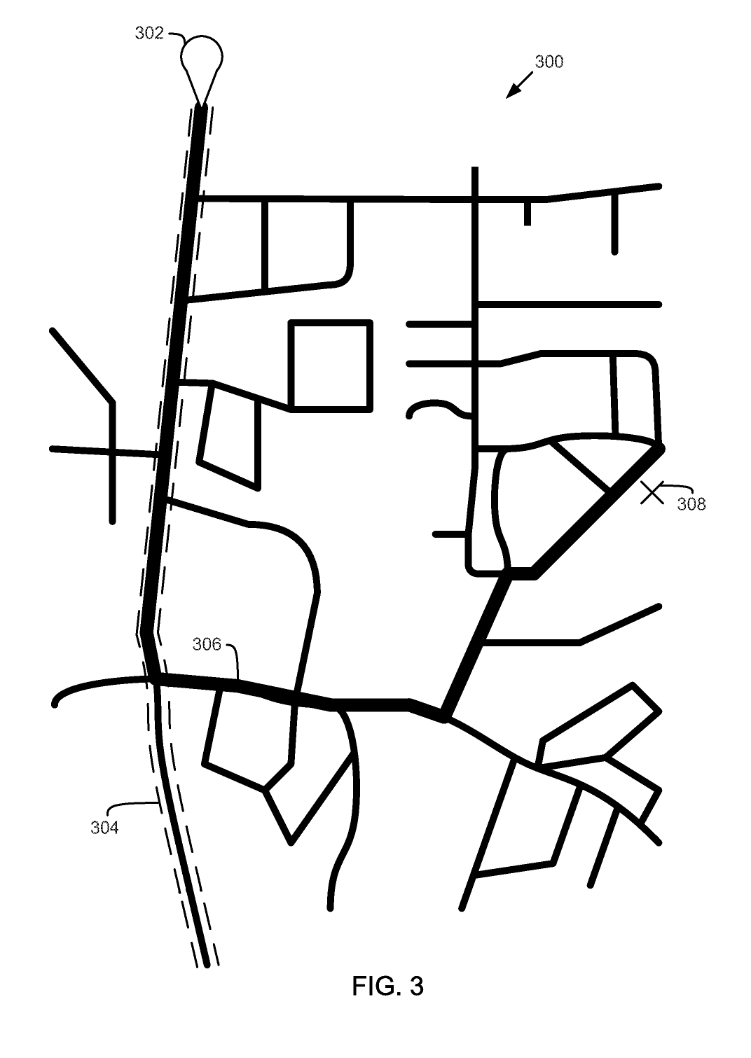

FIG. 3 illustrates a road map 300 for vehicle navigation, according to one embodiment. For example, the road map 300 may be displayed on a display 114 of the vehicle refueling station routing system 100 of FIG. 1. A location 302 of the vehicle is shown. According to one embodiment, a user presses a button on a human interface device 106 while at location 302. The location 302 may be logged by a fueling station component 104. Before the user presses the button of the human interface device 106, the navigation system 102 may be providing instructions to navigate along a first route 304, indicated by dashed lines. In response to the button press, the fueling station component 104 may determine the user's preferences or the vehicle's characteristics and select a fueling location 308 based on those parameters. The navigation system 102 may provide instructions to follow a second route 306 to arrive at the fueling location 308. In one embodiment, the fueling station component 104 and/or navigation system 102 may reroute the vehicle to the fueling location 308 without any input from a user while driving except the button press. Thus, a single button press may allow the user to be rerouted to a fueling location 308 that meets the user's preferences and the vehicle's requirements.

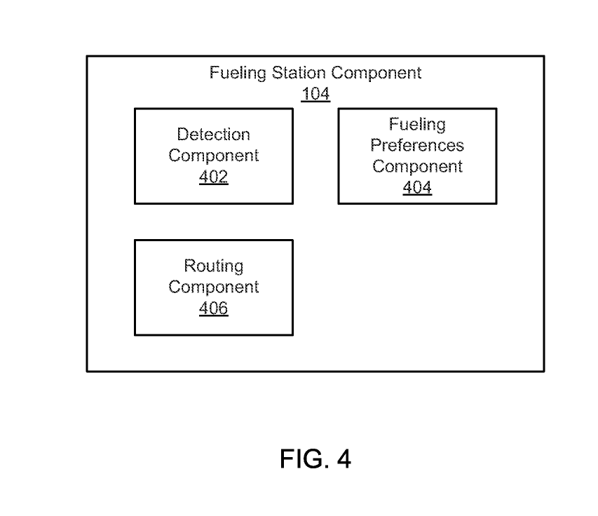

FIG. 4 is a block diagram illustrating example components of a fueling station component 104. In the depicted embodiment, the fueling station component 104 includes a detection component 402, a fueling preferences component 404, and a routing component 406. The components 402-406 are given by way of illustration only and may not all be included in all embodiments. In fact, some embodiments may include only one or any combination of two or more of the components 402-406. Some of the components 402-406 may be located outside the fueling station component 104, such as within the navigation system 102 or elsewhere.

The detection component 402 is configured to detect input on human interface device. In one embodiment, the detection component 402 is configured to detect a button press on the human interface device 106 of FIG. 1. For example, the detection component 402 may receive a signal from the human interface device 106 that indicates that the button has been pressed by a user. In one embodiment, the detection of the button press includes detecting a wireless signal.

For example, the fueling station component 104 or navigation system 102 of FIG. 1 may include a wireless transceiver and may detect a wireless signal from the human interface device 106 that is received by the wireless transceiver. In one embodiment, the detection component 402 may receive a Bluetooth signal, a Wi-Fi signal, and a ZigBee signal, or any other wireless signal from a vehicle accessory that indicates input from the user.

In one embodiment, the detection component 402 may determine and log a current time and a current location of the vehicle when the button press was detected. For example, the detection component 402 may log a current location as determined by a GPS 110 or navigation system 102. The detection component 402 may send a command to a fueling preferences component 404 and/or a routing component 406 to select and route the vehicle to a fueling station in response to detecting input from the user on the human interface device 106.

The fueling preferences component 404 is configured to determine one or more fueling preferences for the vehicle or a user of the vehicle. In one embodiment, the fueling preferences component 404 may determine the fueling preferences by retrieving the vehicle's characteristics or the user's preferences from memory, such as from the data store 108 or from a remote server using a transceiver 112. The fueling preferences may include one or more of a vehicle type, a fuel type, a fuel consumption rate, a time of last refueling, a location of last refueling, a preferred fuel brand, a fueling location brand, and a preferred fuel type.

The vehicle type may include information about an engine, motor, fuel or energy source, fuel or energy usage rate, vehicle length, vehicle brand, vehicle classification (e.g., passenger car, pickup, commercial or the like), minimum vehicle turning radius, or any other information about the vehicle. The fuel type may include one or more of gasoline, diesel, fuel grade, ethanol, electrical, natural gas or the like. The fuel consumption rate may include an approximate amount of energy used by the vehicle such as gallons per mile, Watts per mile, or the like. The time of last refueling may include a date and time at which the vehicle was last refueled. The location of last refueling may include a location or distance from a current location at which the vehicle was last refueled. The preferred fuel brand may include a brand of fuel or energy to refuel the vehicle. The fueling location brand may include a brand or company name for a refueling station or a company that owns or operates a refueling station. The preferred fuel type may include a specific type of fuel that is preferred for the vehicle. For example, a vehicle may be able to refuel or replenish an energy source using a variety of different fuel or energy types. The preferred fuel type may indicate one or more of the possible fuel or energy types that are preferred. For example, a vehicle owner may prefer to refuel using gasoline rather than ethanol.

In one embodiment, the vehicle type and/or user preferences may include information previously entered by the user. For example, a user may enter a vehicle type for a specific vehicle and one or more preferences for the specific vehicle. Later, when the user is driving that specific vehicle, the preferences and characteristics for that vehicle may be retrieved from memory. In one embodiment, the user may enter preferences or characteristics for a plurality of vehicles. Later, when the user uses a specific vehicle, the user may select that specific vehicle within the navigation system or within a mobile application so that the characteristics and preferences used to select a fueling station correspond to the vehicle the user is currently driving or using. In one embodiment, the characteristics and preferences may be stored on a mobile device, navigation system, or at a remote location on a server or other computing device for later retrieval. For in-dash navigation systems, the navigation system may be preprogrammed with vehicle information so that the in-dash navigation system operates according to the vehicle in which it is mounted.

The routing component 406 is configured to select and/or route the vehicle to a desired destination. In one embodiment, the routing component 406 is configured to select a fueling station based on one or more of the vehicle's characteristics or the user's preferences. For example, a data store 108 may include a map or other data that includes information about fueling stations. The routing component 406 may filter the fueling stations by the user's preferences or the vehicle's characteristics. For example, the fueling stations not matching or at least partially matching the fueling preferences may be omitted. The routing component 406 may select the closest fueling station, or the closest fueling station along a current route, that has not been filtered.

Alternatively, the routing component 406 may find all stations within a specific radius along a current route of the vehicle and may filter or order those stations based on distance and how well each of those stations matches the vehicle's characteristics and user's preferences. For example, the stations within the radius may be organized based on weights assigned to the distance and the matches. In one embodiment, only stations that match all characteristics and preferences will be provided, unless there are not any fueling stations within a remaining driving range of the vehicle. For example, the vehicle may have only enough fuel to travel a specific distance. Thus, if no fueling stations within that specific distance are available based on the user's preferences and the vehicle's characteristics, then the routing component 406 may find the closest station that matches a required fuel type for the vehicle.

In one embodiment, the routing component 406 may select a fueling station that can accommodate a specific vehicle type, such as vehicle size. In one embodiment, the routing component 406 may select a fueling station that can provide a specific fuel type. In one embodiment, the routing component 406 may select a fueling station that can be reached by the vehicle based on a current fuel or energy level, a fuel consumption rate, a time of last refueling, and/or a location of last refueling. In one embodiment, the routing component 406 may select a fueling station that has a preferred fuel brand and/or a fueling location brand.

In one embodiment, the routing component 406 may route the vehicle to the selected fueling station. In one embodiment, the routing component 406 may route the vehicle to the selected fueling station by providing the fueling station or the location of the fueling station to a navigation system 102. For example, a mobile computing device that includes the routing component 406 may provide the fueling station or the location of the fueling station to an in-dash navigation system for navigation to the fueling station.

In one embodiment, the routing component 406 may route the vehicle to the selected fueling station by selecting a route along one or more roads to the fueling station. For example, the routing component 406 may calculate a route from the current location of the vehicle to the selected fueling station. In one embodiment, the routing component 406 may select a route that can accommodate a vehicle type of the vehicle. For example, if the vehicle is an eighteen wheel semi-truck with a trailer, the routing component 406 may avoid residential areas or smaller roads when larger roads or roads through non-residential areas are available.

In one embodiment, the routing component 406 may select a fueling location without further input from the user. For example, the routing component 406 may, in response to a single button press, select a fueling station and route to the fueling station based on the available vehicle characteristics and user preferences. Thus, the user may only be required to press an easy to access button in order to reroute the vehicle to a fueling location. The user may not be required to search through a list of nearby fueling stations to select one that accommodates the user's preferences or vehicle's characteristics. In one embodiment, the user can press the button and then wait and follow navigation instructions to arrive at the selected fueling station.

In one embodiment, each button press by a user may select a new fueling station or cycle through a top number of fueling stations. For example, the user may press the button a first time and realize that the navigation instructions are leading the user to a fueling station that is too far out of the user's way or is otherwise not desirable. As another example, a user may simply want to see a few other options for the available fueling stations. In one embodiment, each button press may result in the fueling station component 104 automatically selecting and providing routing instructions to a different station, such as by cycling through the top five or top ten matches. Thus, the user may be able to cycle through the available fueling stations to select the one the user prefers most. In one embodiment, routing component 406 may reroute the vehicle from a first fueling location to a second fueling location in response to a second press on the button.

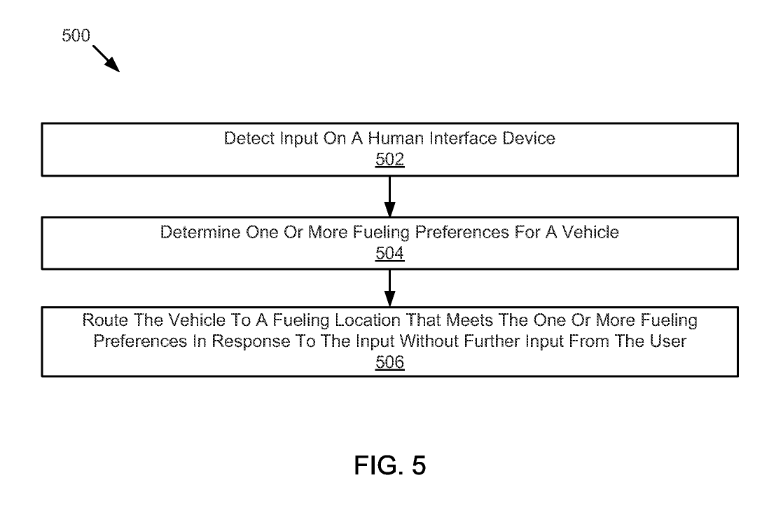

Referring now to FIG. 5, a schematic flow chart diagram of a method 500 for routing a vehicle to a fueling location is illustrated. The method 500 may be performed by a navigation system or a fueling station component, such as the navigation system 102 of FIG. 1 or the fueling station component 104 of FIG. 1 or 4.

The method 500 begins and a detection component 402 detects input on a human interface device 106 at 502. For example, the detection component 402 may detect a button press on the human interface device 106 separate from a navigation system 102 or fueling station component 104 based on a signal received from the human interface device 106. A fueling preferences component 404 may determine one or more fueling preferences for the vehicle at 504. For example, the fueling preferences component 404 may retrieve the fueling preferences from memory. A routing component 406 routes the vehicle (or a driver of the vehicle) to a fueling location that meets the one or more fueling preferences at 506. For example, in response to the button press detection by the detection component 402 at 502, the routing component 406 may reroute the vehicle to a fueling location that meets the one or more fueling preferences for the vehicle without further input from a user.

### Examples

The following examples pertain to further embodiments.

Example 1 is a method that includes detecting, at a navigation system, a button press on a human interface device separate from the navigation system based on a signal received from the human interface device. The method also includes determining one or more fueling preferences for a vehicle. The method also includes, in response to the button press, rerouting a vehicle to a fueling location that meets the one or more fueling preferences for the vehicle without further input from a user.

In Example 2, determining the one or more fueling preferences in Example 1 includes determining information about the vehicle comprising one or more of a vehicle type, a fuel type, a fuel consumption rate, a time of last refueling, and a location of last refueling.

In Example 3, determining the one or more fueling preferences in any of Examples 1-2 includes determining one or more of a preferred fuel brand, a fueling location brand, and a preferred fuel type.

In Example 4, determining the one or more fueling preferences in any of Examples 1-3 includes retrieving at least one fueling preference from memory.

In Example 5, rerouting the vehicle in any of Examples 1-4 includes routing the vehicle along a route that can accommodate a vehicle type of the vehicle.

In Example 6, detecting the button press in any of Examples 1-5 includes detecting a wireless signal.

In Example 7, detecting the wireless signal in Example 6 includes detecting one or more of a Bluetooth signal, a Wi-Fi signal, and a ZigBee signal.

In Example 8, the navigation system in any of Examples 1-7 includes a mobile computing device, and wherein detecting, determining, and routing are performed by a processor on the mobile computing device based on an application on the mobile computing device.

In Example 9, the navigation system of any of Examples 1-7 includes a dash mounted navigation system.

Example 10 is a system that includes a human interface device having a button and a transceiver, wherein the transceiver is configured to send a signal in response to a press on the button by a user. The system also includes a GPS receiver, one or more processors, and computer readable storage media storing instructions. The instructions, when executed by one or more processors, cause the processors to detect the press on the button based on the signal received from the human interface device, determine one or more fueling preferences for a vehicle, and reroute the vehicle to a fueling location that meets the one or more fueling preferences for the vehicle without further input from a user.

In Example 11, the button in Example 10 includes a mechanical button mounted within the vehicle.

In Example 12, the mechanical button in Example 11 is mounted on a steering wheel of the vehicle.

In Example 13, the system of any of Examples 10-12 includes a mobile computing device, wherein the mobile computing device comprises the GPS receiver, the one or more processors, and the computer readable storage media.

In Example 14, the press on the button in any of Examples 10-13 includes a first press and the fueling location includes a first fueling location. The instructions further cause the processor to reroute the vehicle to a second fueling location in response to a second press on the button.

In Example 15, the instructions in any of Examples 10-14 further cause the processor to determine a current time and a current location of the vehicle corresponding to the button press, and wherein rerouting the vehicle comprises rerouting based on the current time and the current location.

Example 16 is an apparatus that includes a detection component, a fueling preferences component, and a routing component. The detection component is configured to detect a press of a button device based on a wireless signal received from the button device, wherein the button device is independent from the apparatus. The fueling preferences component is configured to determine one or more fueling preferences for a vehicle, wherein the one or more fueling preferences comprise one or more of a vehicle type, a fuel type, and a brand of a fueling location. The routing component is configured to reroute the vehicle to a fueling location that meets the one or more fueling preferences for the vehicle without further input from a user.

In Example 17, the fueling preferences component of Example 16 is configured to determine one or more of a vehicle type, a fuel type, a fuel consumption rate, a time of last refueling, a location of last refueling, a preferred fuel brand, a fueling location brand, and a preferred fuel type.

In Example 18, the routing component in any of Examples 16-17 is configured to route the vehicle to the fueling location along a route that can accommodate the vehicle type.

In Example 19, the apparatus of any of Examples 16-18 further includes a wireless transceiver and the detection component is configured to detect the button press by identifying a wireless signal from the button device received by the wireless transceiver.

In Example 20, the routing component in any of Examples 16-19 is configured to reroute the vehicle based on a current time and a current location of the vehicle.

Example 21 is a system that includes means for implementing a method or realizing a system or apparatus of any of Examples 1-20.

It should be noted that the embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

Embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1-20. (canceled)

21. A computer-implemented method comprising:
detecting, at a navigation system, a button press on a human interface device separate from the navigation system based on a signal received from the human interface device;
determining one or more fueling preferences for a vehicle; and
in response to the button press, rerouting the vehicle to a fueling location that meets the one or more fueling preferences for the vehicle without further input from a user.

22. The method of claim 21, wherein determining the one or more fueling preferences comprises determining information about the vehicle comprising at least one or more of a vehicle type, a fuel type, a fuel consumption rate, a time of last refueling, and a location of last refueling.

23. The method of claim 21, wherein determining the one or more fueling preferences comprises determining at least one or more of a preferred fuel brand, a fueling location brand, and a preferred fuel type.

24. The method of claim 21, wherein determining the one or more fueling preferences comprises retrieving at least one fueling preference from memory.

25. The method of claim 21, wherein rerouting the vehicle comprises routing the vehicle along a route that can accommodate a vehicle type of the vehicle.

26. The method of claim 21, wherein detecting the button press comprises detecting a wireless signal.

27. The method of claim 26, wherein detecting the wireless signal comprises detecting one or more of a Bluetooth signal, a Wi-Fi signal, and a ZigBee signal.

28. The method of claim 21, wherein the navigation system comprises a mobile computing device, and wherein detecting, determining, and routing are performed by a processor on the mobile computing device based on an application on the mobile computing device.

29. The method of claim 21, wherein the navigation system comprises a dash mounted navigation system.

30. A system comprising:
a human interface device comprising a button and a transceiver, the transceiver configured to send a signal responsive to button activation; and
a processor configured to:
detect the button activation based on receipt of the signal,
determine a predefined vehicle fueling preference, and
route the vehicle to a fueling location that meets the fueling preference without further user input following button activation.

31. The system of claim 30, wherein the button comprises a mechanical button mounted within the vehicle.

32. The system of claim 31, wherein the mechanical button is mounted on a steering wheel of the vehicle.

33. The system of claim 30, wherein a mobile computing device includes the processor.

34. The system of claim 30, wherein the button activation comprises a first press and the fueling location comprises a first fueling location, wherein the the processor is further configured to route the vehicle to a second fueling location in response to a second button activation.

35. The system of claim 30, wherein processor is further configured to determine a current time and a current location of the vehicle corresponding to the button press, and wherein routing the vehicle comprises routing based on the current time and the current location.

36. A system comprising:
a processor configured to:
detect a press of a vehicle-mounted, but otherwise unconnected button device, based on a wireless signal received from the button device;
determine a vehicle fueling preferences, wherein the preference including at least one of a vehicle type, a fuel type, or a fuel brand; and
route the vehicle to a fueling location that meets the vehicle fueling preference without further user input.

37. The system of claim 36, wherein the preference further includes at least one of a vehicle type, a fuel type, a fuel consumption rate, a time of last refueling, a location of last refueling, a preferred fuel brand, a fueling location brand, or a preferred fuel type.

38. The system of claim 36, wherein the processor is configured to route the vehicle to the fueling location along a route that can physically accommodate the vehicle type.

39. The system of claim 36, further including a wireless transceiver, wherein the processor is configured to detect the button press by identifying a wireless signal from the button device received by the wireless transceiver.

40. The system of claim 36, wherein the processor is configured to route the vehicle based on a current time and a current location of the vehicle.
